(19) United States
(12) Patent Application Publication
(10) Pub. No.: US 2026/0322614 A1
(43) Pub. Date: Oct. 15, 2026

(54) Systems And Methods For Secure Biometric Recognition Using Efficient Neural Networks

(71) Applicant: Board of Trustees of Michigan State University, East Lansing, MI (US)

(72) Inventors: Vishnu Naresh BODDETI, Okemos, MI (US); Wei Ao, East Lansing, MI (US)

(21) Appl. No.: 19/634,245

(22) Filed: Mar. 31, 2026

Related U.S. Application Data
(60) Provisional application No. 63/785,711, filed on Apr. 9, 2025.

(51) Int. Cl. H04L 9/32; H04L 9/00

(52) U.S. Cl. CPC H04L 9/3231; H04L 9/008

(57) ABSTRACT

A method and system for performing secure biometric recognition includes encrypting a biometric sample to form encrypted biometric data, communicating the encrypted biometric data to a feature extractor, extracting features from the encrypted biometric data to form encrypted extracted features, performing a biometric verification or a search on the encrypted extracted features, forming an encrypted output signal based on results of the verification or the search and communicating the encrypted output signal to a client device.

### CROSS-REFERENCE TO RELATED APPLICATIONS

This application claims the benefit of U.S. Provisional Application No. 63/785,711, filed on Apr. 9, 2025. The entire disclosure of the above application is incorporated herein by reference.

### FIELD

The present disclosure relates to biometric recognition and, more specifically, to a secure biometric recognition system.

### BACKGROUND

This section provides background information related to the present disclosure which is not necessarily prior art.

Face Recognition (FR) has become integral to identity management in many practical applications, from unlocking personal devices to facilitating law enforcement and accessing financial services. These systems process sensitive biometric data that, if compromised, can lead to privacy invasions, identity theft, and unauthorized surveillance. Unlike passwords, biometric data is immutable. Once compromised, it cannot be changed, which elevates the need for robust security mechanisms to protect it. Such protections are also mandated by legal regulations on the acquisition, storage, and usage of biometric data, e.g., the European Union's General Data Protection Regulation (GDPR). FR systems in the wild consist of three entities: a probe face image, a feature extractor (i.e. a FR neural network), and a reference database of face features.

The feature extractor processes a face image to generate its corresponding compact feature representation.

FR systems meet increasing security challenges. An adversarial client could attempt to infer biometric data from the server's reference database or leverage the feature extractor to generate adversarial probes to deceive the system. Similarly, an adversarial server might exploit client-provided data to extract biometric information or infer sensitive attributes such as gender, age, or race. Existing secure FR systems apply fully homomorphic encryption (FHE) in a client-server two-party scenario to ensure security of face features. FHE allows computation over encrypted data and provides provable post-quantum security. As shown in FIG. 1A, a client device 10 is in communication with a server 12 through a network 14. A probe feature of the client device 10 communicates with a reference database 16 at the server 16 encrypted with FHE through the network 14. The client device 10 performs feature extraction locally using a neural network 18 to obtain a feature 20 and cannot delegate this task to the server 16. An encryption device 22 encrypts the feature to form an encrypted feature 24. In other words, a probe feature 20 is extracted and encrypted as an encrypted feature 24 in the client device 10 and then sent to the server 12 and finally compared to the enrolled feature from a reference database 16. Verification is performed by the server 16 directly within the encrypted domain using the encrypted feature communicated through the network 14 and a score function 26 which may be a cosine function or L2 distance. A claimed identifier 30 is communicated to the server 16 also through the network 14. Limiting security measures to feature protection reduces the practical utility of such systems. Moreover, such a secure FR system is vulnerable to the recovery attack. An adversarial client could attempt to infer features in the server's reference database 16.

Homomorphic encryption (HE) is a class of encryption schemes that are considered quantum-secure and enable computations on encrypted data without requiring decryption. FHE schemes are based on the Learning with Errors (LWE) problem or Ring Learning with Errors (RLWE). Among different HE schemes, the Cheon-Kim-Kim-Song (CKKS) encryption scheme is particularly well-suited for encrypted inference in neural networks since it supports fixed-point approximate arithmetic over complex (and real) numbers.

A cleartext message vector

$$m ∈ {C}^{\frac{N}{2}}$$

is first encoded into a plaintext message, which is subsequently encrypted into a ciphertext c using a public key pk−(−(α, sk)+e, α). Here, a is a random vector, e is a noise vector, and skis the secret key. The encryption and decryption processes are defined as follows:

$$\begin{matrix}Encrypt ( m , pk ) c = ( m , 0 ) + pk = ( {c}_{0} , {c}_{1} ) = c \\ Decrypt ( c , sk ) = {c}_{0} + \text{?} {c}_{1} , s k \text{?} = m + e\end{matrix} \qquad ( 1 )$$

The CKKS scheme uses a residue cyclotomic polynomial ring [symbol] = [symbol] [X]/(X^{N}+1) to encode cleartext vectors. The modulus is defined as

$${Q}_{ℓ} = {\prod }_{i = 0}^{ℓ} {q}_{l} 0 \leq ℓ \leq L .$$

The polynomial degree N determines the message capacity, allowing

$$\frac{N}{2}$$

complex numbers to be packed into

$$\frac{N}{2}$$

slots

The CKKS scheme supports two homomorphic operations-additional and multiplication- and one automorphic operation, rotation. These operations are defined as follows:

$$\begin{matrix}{\underbrace{[ {m}_{1} ] ⊕ [ {m}_{2} ]}}_{ciphertext - ciphertext} & \approx & {\underbrace{[ {m}_{1} ] ⊕ {m}_{2}}}_{ciphertext - plaintext} & \approx & {[ \underbrace{{m}_{1} + {m}_{2}} ]}_{element - wise add} \\ {\underbrace{[ {m}_{1} ] ⊗ [ {m}_{2} ]}}_{ciphertext - ciphertext} & \approx & {\underbrace{[ {m}_{1} ] ⊗ {m}_{2}}}_{ciphertext - plaintext} & \approx & {[ \underbrace{{m}_{1} \times {m}_{2}} ]}_{element - wise mul}\end{matrix} \qquad ( 2 )$$

$$Rot ( [ m ] , r ) = [ Rot ( m , r ) ]$$

Here, [·] represents an encrypted vector, i.e. [m]=c, and Rot(·) denotes a left cyclical rotation of the vector by r positions. Homomorphic addition ( ) and multiplication ( ) can be applied between two ciphertexts or between a ciphertext and plaintext, enabling element element-wise computations.

Each ciphertext is associated with a level [symbol] [symbol] , an integer indicating the number of homomorphic multiplications that can be performed before decryption fails. A function with a multiplicative [symbol] -defined as the number of sequential homomorphic multiplications it involves-consumes [symbol] levels. After each multiplication, the polynomial modulus [symbol] must be rescaled, transitioning from [symbol] to [symbol] to correct the scale.

CKKS without bootstrapping is a leveled homomorphic encryption (LHE) scheme, allowing a limited number of multiplications determined by the initial level L of a freshly encrypted ciphertext. To evaluate functions with arbitrary depth, fully homomorphic encryption ( [symbol] ) incorporates a bootstrapping operation to refresh ciphertexts, effectively resetting their level to enable further computation. For deeper neural networks, bootstrapping must be periodically applied to prevent decryption failures. However, this process is computationally expensive, with high latency due to the large number of rotation operations involved. Additionally, bootstrapping has a significant memory footprint because of the large size of the bootstrapping key. While a freshly encrypted ciphertext starts with L levels, bootstrapping reduces the available levels to L-K, as K levels are consumed during the evaluation of polynomials required for bootstrapping.

In terms of relative computational cost, bootstrapping is much slower than other FHE operations: bootstrapping>>rotation or ciphertext-ciphertext multiplication>>addition or ciphertext-plaintext multiplication.

Under the HE scheme, homomorphic CNNs (HCNNs) are based on supported HE operations in Equation 2. HCNNs are categorized into [symbol] and LHENets depending on whether bootstrapping is used or not, respectively. Famous LHENets include CryptoNets, LoLa, Faster CryptoNets, while recent FHENets include MPCNN and AutoFHE. FHENets show SoTA prediction accuracy on image classification datasets with much higher latency than LHENets. Existing HCNNs to speed up the inference on encrypted images have focused on two aspects, convolutional packing and polynomial activation.

Convolutional Packing refers to efficiently packing three-dimensional tensors to reduce the complexity of HE multiplication and rotation for convolutional layers. MPCNN designs multiplexed convolution integrating (1) repeating packing and (2) multiplexed packing. A ciphertext with the cyclotomic polynomial degree N can pack

$$\frac{N}{2}$$

numbers. Given a vector (x)∈R^{d} with

$$d < \frac{N}{2} ,$$

a repeated vector is x^{M}=[x, x, . . . , x] with

$$M = [ \frac{N}{2 d} ]$$

copies of x. x^{(M)} is encrypted to fill out all slots. The repeated packing can accelerate convolution and bootstrapping operations. When Mis bigger, the inference is faster. (2) It will generate gaps between useful numbers when the convolutional stride is bigger than 1. Hence, the ciphertext will not use all slots. MPCNN alternately packs numbers from different channels to fill these gaps to use all slots and prevent the ciphertext from becoming sparse. Channels are computed in parallel to speed up convolutional layers.

Polynomial Activation has been used. HCNNs cannot apply ReLU because it is not a homomorphism. HCNNs tailor polynomial activations to replace ReLU. Monomial, Chebyshev and Hermite polynomials are applied in HCNNs. Monomial polynomial is most widely used because it formulates HCNNs as traditional polynomial networks, i.e. CryptoNets, LoLa and Faster CryptoNets. It observed unstable training due to the exploding problems introduced by monomial polynomials. Minimax approximation using Chebyshev polynomials can approximate ReLU with high precision. However, the high-degree polynomial results in a prohibitive high multiplicative depth. AESPA introduces low-degree Hermite polynomials to reduce the depth and proposes basis-wise normalization to stabilize the training. Search-based AutoFHE explored layer-wise mix-degree polynomials to further decrease the depth.

### SUMMARY

This section provides a general summary of the disclosure, and is not a comprehensive disclosure of its full scope or all of its features.

This invention disclosure describes a secure biometric recognition method in which all sensitive data remains encrypted throughout the entire recognition pipeline. The system encrypts an input biometric sample (such as a fingerprint, iris scan, or facial image) before sending it to a server or processor for feature extraction and biometric verification or search. By employing encryption techniques that allow computation directly on ciphertexts, the method ensures that the server never sees raw biometric data in unencrypted form. This helps protect individuals' privacy and secures biometric information against malicious attacks or unauthorized access.

To efficiently handle the computational overhead introduced by encrypted operations, the system uses an encryption-compatible neural network that divides a biometric sample into manageable “patches.” Each patch is processed by a shallow, specialized network that runs in parallel. By keeping these networks relatively shallow, the overall multiplicative depth- and thus the latency associated with homomorphic encryption-is greatly reduced. After local features are extracted from each patch, a lightweight fusion step aggregates the local patch features from each patch to form a robust global representation. This design scales to various biometric modalities and resolutions, delivering improved speed and performance for end-to-end encrypted biometric recognition.

The present description is set forth with regard to facial recognition. However, other types of biometrics may benefit from the teachings herein such as but not limited to fingerprints, voice, gait, retina and iris recognition.

Face recognition is central to many authentication, security, and personalized applications. Yet, it suffers from significant privacy risks, particularly concerning unauthorized access to sensitive biometric data. The present disclosure paper introduces CryptoFace, the first end-to-end encrypted face recognition system with fully homomorphic encryption (FHE). It enables secure processing of facial data across all stages of a face-recognition process-feature extraction, storage, and matching-without exposing raw images or features. Shallow patch convolutional networks are used to support higher-dimensional tensors via patch-based processing while reducing the multiplicative depth and thus inference latency. Parallel FHE evaluation of these networks ensures near-resolution-independent latency. On popular face recognition benchmarks, CryptoFace significantly accelerates inference and increases verification accuracy compared to state-of-the-art FHE neural networks adapted for face recognition. CryptoFace will facilitate secure face recognition systems requiring robust and provable security.

In one aspect of the disclosure, a method of performing secure biometric recognition includes encrypting a biometric sample to form encrypted biometric data, communicating the encrypted biometric data to a feature extractor, extracting features from the encrypted biometric data to form encrypted extracted features, performing a biometric verification or a search on the encrypted extracted features, forming an encrypted output signal based on results of the verification or the search and communicating the encrypted output signal to a client device.

In another aspect of the disclosure, a system for performing secure biometric recognition includes a client device encrypting a biometric sample to form encrypted biometric data. The system further includes a server and a feature extractor receiving the encrypted biometric data through a network, the feature extractor extracting features from the encrypted biometric data to form encrypted extracted features. The server performs a biometric verification or a search on the encrypted extracted features, forming an encrypted output signal based on results of the verification or the search, and communicating the encrypted output signal to a client device.

In another aspect of the controller, a method for performing secure biometric recognition includes encrypting a facial image in patches to form a plurality of encrypted patches, communicating the encrypted patches to a feature extractor though a network, extracting features from the encrypted patches to form encrypted extracted features, performing a biometric verification or a search on the encrypted extracted features, forming an encrypted output signal from the based on results of the verification or the search and communicating the encrypted output signal to a device.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a block diagrammatic view of a prior art biometric recognition system.

FIG. 2A is a block diagrammatic view of an offline biometric recognition system according to the present disclosure.

FIG. 2B is a block diagrammatic view of an online biometric recognition system according to the present disclosure.

FIG. 3A is a block diagrammatic view of a training system with patches for the biometric recognition system according to the present disclosure.

FIG. 3B is a block diagrammatic view of an inference generator system with patches for the biometric recognition system according to the present disclosure.

FIG. 4A is a block diagrammatic view of a ResNet system.

FIG. 4B is a block diagrammatic view of an AESPA system.

FIG. 5A is a block diagrammatic view of the CryptoFaceNet block, stride 1 according to the present disclosure.

FIG. 5B is a block diagrammatic view of the CryptoFaceNet block, stride 2 according to the present disclosure.

FIG. 6 is block diagrammatic view of a two-dimensional adaptive average pooling system.

FIG. 7A is a detailed diagrammatic view of the CryptoFaceNet system for training.

FIG. 7B is a detailed diagrammatic view of the CryptoFaceNet system for homomorphic inference.

FIG. 8A is a table of a comparison of different facial recognition latencies with different data sets.

FIG. 8B is another table of a comparison of latencies of operations.

FIG. 9A is plot of distributions of the domains of L2 polynomial approximation on different datasets.

FIG. 9B is a plot of L2 polynomial approximation error log.

FIG. 10A are experimental results on encrypted IJB-B and IJB-C on FHE.

FIG. 10B are experimental results for a 1:128 closed-set rank retrieval task under FHE, using a randomly selected subset of LFW consisting of 128 pairs.

Corresponding reference numerals indicate corresponding parts throughout the several views of the drawings.

### DETAILED DESCRIPTION

Example embodiments will now be described more fully with reference to the accompanying drawings.

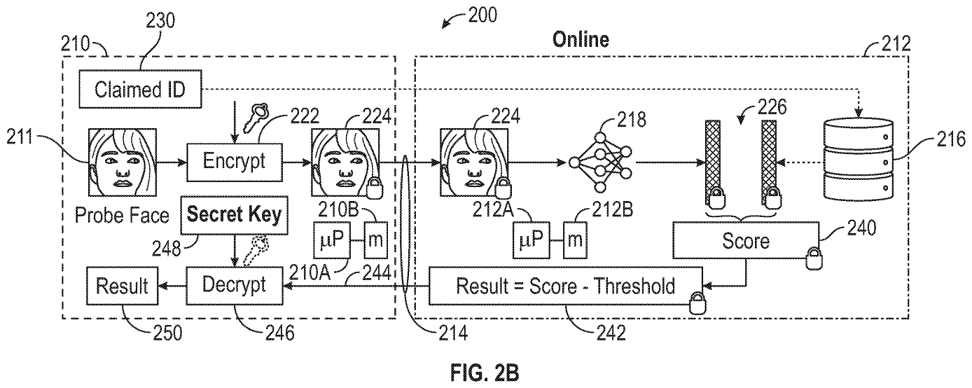

Referring now to FIGS. 2A and 2B, a system 200 for performing secure biometric recognition includes a client device 210 in communication with a server 212 through a network 214. The client device 210 has a microprocessor or processor 210A is illustrated coupled to a memory 210B. Although one processor 2102A is illustrated several may be used in the system. The memory 210B may be a non-transitory computer-readable medium that includes instructions that are executable by the processor. The instructions may include instructions for performing biometric recognition, controlling communication with the server 212 and controlling displaying results. The server 212 also has a microprocessor or processor 212A is illustrated coupled to a memory 212B. Although one processor 212A is illustrated several may be used in the system. The memory 212B may be a non-transitory computer-readable medium that includes instructions that are executable by the processor. The instructions may include instructions for performing biometric recognition, performing searches or biometric verification and receiving data from the client device 210.

A face image 211 for identification is used. The same refence numbers are used in FIGS. 2A and 2B for the same components. FIG. 2A may be referred to as off-line and FIG. 2B as on-line.

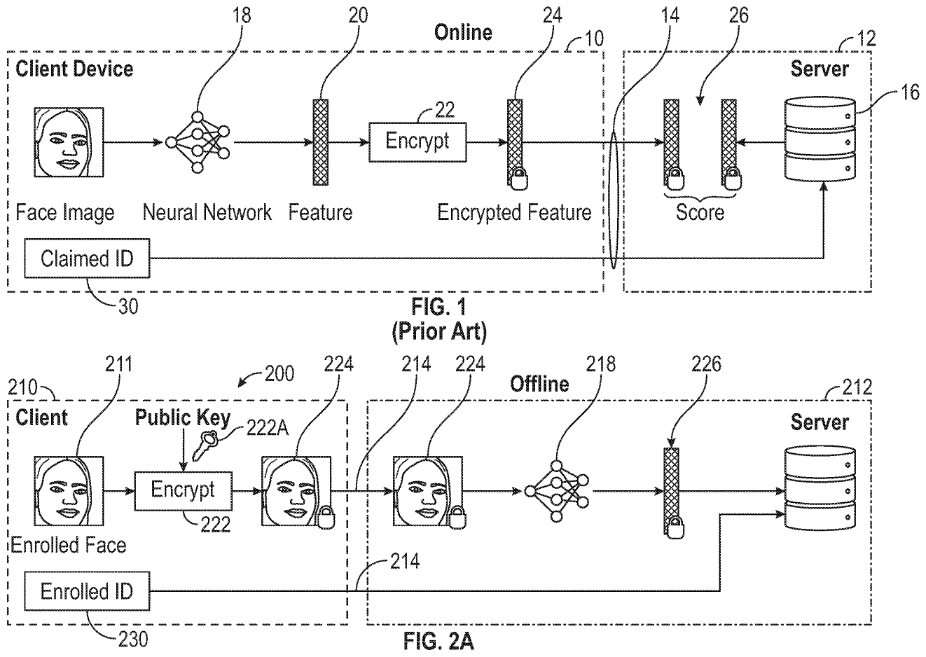

The client device 210 communicates with a reference database 216 at the server 212 encrypted with FHE through the network 214. The client device 210 does not perform feature extraction locally as in FIG. 1 Instead, a neural network 218 located at the server 212 is used to obtain a features and perform recognition. An encryption device 222 encrypts the face image or other biometric data rather than the features to form an encrypted biometric data 224 which could be an encrypted image or patches as described below. Verification is performed by the server 216 directly within the encrypted domain using the encrypted image communicated through the network 214 using the cosine function 226. A claimed identifier 30 is communicated to the server 16 also through the network 14.

The server 216 uses a neural network (NN) to extract an encrypted feature. This encrypted feature is matched against the encrypted reference feature stored in the server's database 216, producing an encrypted similarity score 240. The score 240 is compared against a threshold in a comparator 242, and the encrypted match/no-match result 244 is consequently encrypted and is returned to the client device 210, who can only decrypt the encrypted output signal in a decoder 246 with the secret key 248. A display 250 may display a decrypted result. By securing the user's sensitive biometric data throughout the verification process and protecting the server's reference database, CryptoFace offers robust end-to-end security for FR systems. Realizing this goal presents three major technical challenges. (1) Homomorphic evaluation of state-of-the-art (SoTA) convolutional neural networks (CNNs) is computationally demanding due to the high multiplicative depth of CNNs. (2) While several approaches have demonstrated homomorphic evaluation of CNNs on low-resolution images. They cannot naively process higher-resolution face images. (3) FR necessitates cosine similarity measure which is not supported by FHE. Existing secure FR bypassed evaluation of cosine function on FHE because features are normalized before encryption.

FR Models take advantage of the outstanding representation learning ability of CNNs to extract discriminative features. Given a face image x∈ [symbol] ^{C×H×W}, a neural network f_{w}(·) with trainable parameters ω, and the feature y=f_{w}(x)∈ [symbol] ^{d}. To verify if two face images x₁, x₂ belong to the same individual, their features y₁=f_{w}(x₁) and y₂=f_{w}(x₂) are compared to obtain a similarity, i.e. Score

$$( {y}_{1} , {y}_{2} ) = {‖ \frac{y 1}{‖ y 1 ‖} - \frac{y 1}{‖ y 1 ‖} ‖}^{2} = 2 - 2 \frac{{y}_{1} {y}_{2}}{‖ {y}_{1} ‖ ‖ {y}_{2} ‖} .$$

If Score (y₁, y₂) is smaller than a predefined threshold T, the two face images are classified as corresponding to the same person. This process is formulated as a Match function:

$$Match ( y 1 , y 2 ) = \text{?} \frac{y 1}{‖ y 1 ‖} , \frac{y 2}{‖ y 2 ‖} \text{?} - T \qquad ( 3 )$$

To train a neural network f_{w}(·) for FR, the feature center W∈ [symbol] ^{M×d} is learned on the training dataset X. The dataset X includes M identifies, each with multiple face images, d is the predefined dimension of features. In this paper, the additive angular margin ArcFace loss is applied which is a modified Cross Entropy loss.

$${L}_{ArcFace} ( w ) = - log \frac{{e}^{s cos ( {ϕ}_{i} + m )}}{{e}^{s cos ( {ϕ}_{i} + m )} + {Σ}_{j + 1 , j \neq 1}^{M} {e}^{s cos ϕ} j} \qquad ( 4 )$$

In addition to the parameters ω, there is a feature center W∈ [symbol] ^{M×d} with M d-dimensional features. Given a training sample x with identity i, the feature y=f_{w}(x). The cosine similarity values between y and M d-dimensional features of the feature center are obtained. In Equation 4, θᵢ is the angle between y and M[i], while θⱼ is the angle between y and M[j], j≠i. The additive margin m is added to the angle θᵢ. The scalar s increases the capacity of the unit ball. Face verification includes two phases, enrollment and verification. In the enrollment stage, the client sends the server a reference face image and corresponding identity. The server applies the trained network to extract the feature from the reference face image and stores the feature and identity. In the verification stage, the client sends a probe face image and a claimed identity to the server. The server applies the same network to extract the feature from the probe face image and compares it with the reference feature indexed by the claimed identity.

Encrypted FR comprises two similar phases, offline and online as shown in FIGS. 2A and 2B, respectively. The offline stage is similar to enrollment, and the online stage is analogous to verification. In the offline stage of FIG. 2A, the client device 210 generates a secret key 222A to encrypt the reference face image and sends the encrypted reference face image and the corresponding identity to the server 212. The server 212 extracts the encrypted feature [y1]=f_{w}([x₁]). The client device 210 does not need to wait to complete the offline stage. The client device 210 has to wait for the result in the online stage, and the online stage's latency matters in real-world applications. In the online stage of FIG. 2B, the client device 210 encrypts a probe image [x₂] and sends the encrypted probe face image and a claimed identity to the server 212. The server 212 extracts the encrypted feature [y₂]=f_{w}[x₂]. Then, the server 212 conducts the match function (Equation 3) over the encrypted features, namely Match ([y₁], [y₂]). Finally, the server 212 sends an encrypted matching result to the client device 210, i.e., Match ([y₁], [y₂]). The client device 210 uses the secret key to decrypt the result and check if it is negative or positive to determine a match or no match, respectively.

The threat model is inspired by existing encrypted FR systems and recent FHENets, two semi-honest parties, a client and a server, are assumed where only one of them is possible to be corrupted by an adversary. The client and the server obey the protocol but try to learn information from each other by exploiting the received information.

If the client is adversarial, it could attempt to infer encrypted features stored on the server. Encrypted feature extraction is conducted on the server and will not be released to the client. The client can only see the matching result, a positive or negative scalar. Thus, the adversarial client cannot infer encrypted features stored on the server.

If the server is adversarial, it could attempt to collect biometric data from the client. The server holds encrypted face images and features but does not have access to the secret key. So, the server cannot learn face images or features from the client.

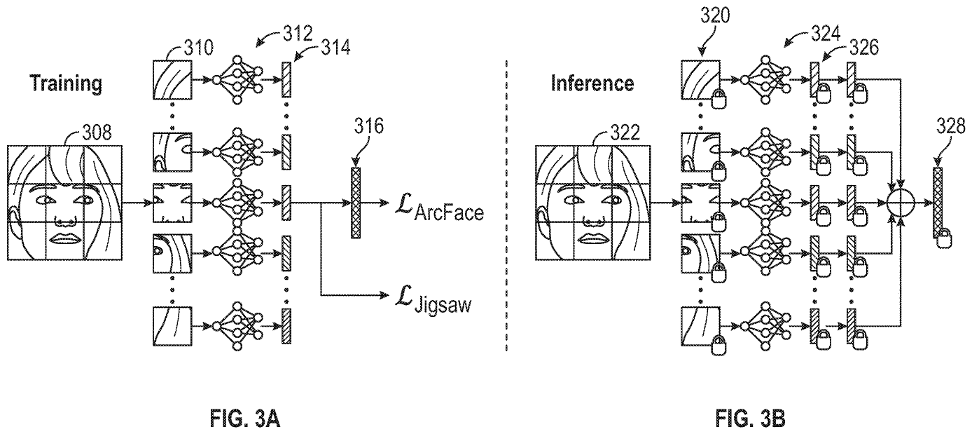

Referring now to FIGS. 3A and 3B, CryptoFaceNet may use a patch-based system. CryptoFaceNet applies a mixture of PCNNs to extract local features and fuse these local features to obtain a global feature. CryptoFaceNet greatly reduces FHE latency thanks to shallow networks with a smaller multiplicative depth and parallelized evaluation on FHE.

While CKSS was used, different types of FHE may be used such as BFV, BGV, and TFHE.

The training process on plaintext data is shown in FIG. 3A. A two-dimensional face image 308 x∈ [symbol] ^{C×H×W} is split to a sequence of patches 310 at the server 212 or at the client device 210 {xᵢ∈ [symbol] ^{C×P×P}}

$$\frac{L}{i = 1}$$

where L=HW/P². The patches are small portion of the biometric data such as images. The image splitting may be the same as Vision Transformer (ViT). The mixture of PCNNs 312 is a set of CNNs, namely

$${\{ {f}_{wi} \}}_{i = 1}^{L} .$$

Each PCNN 312 independently process a respective patch 310 to get a local feature 314 yᵢ∈ [symbol] ^{d}, 1≤i≤L. L local features 314 are fused to obtain the global feature 316 used for face recognition:

y=y′^{A}^{^{T}}+b, where y′=[y1,y2, . . . ,yL] (5)

where A∈ [symbol] ^{d×dL} and b∈ [symbol] ^{d}. The ArcFace loss in Equation 4 are applied to train the mixture of PCNNs. To better learn the relationship between PCNNs, a jigsaw puzzle task has been shown to effectively learn position information and is naturally suitable for a mixture of PCNNs. Features y1, y2, . . . , y_{L} are used to predict their corresponding locations, i.e. 1, 2, . . . , L. A fully connected layer is used to predict jigsaw locations. Hence, the local features can learn the positional information. The training loss of the mixture of PCNNs is:

L(w)=L_{ArcFace}(W)+αL_{Jigsaw}(W) (6)

Relative to inference in FIG. 3B, the mixture of PCNNs applies a set of shallow CNNs with limited layers. Because the patch size of a patch 320 of the image 322 is much smaller than the original image, P<<M or P<<N, it leads to a smaller receptive field. Shallower CNNs 324 are applied to each patch 320. A patch 320 usually includes a small structure of faces. The mixture of PCNNs learn their filters separately rather than via weight sharing. The acceleration is two-fold when an encrypted face image 322 is evaluated using the proposed mixture of PCNNs. First, the multiplicative depth is greatly reduced. One bootstrapping operation is used. Second, L PCNNs are evaluated in parallel. The proposed parallelism makes engineering easy. However, the fusion of local features 326 to obtain the global feature 328 uses a big vector-matrix product y′A^{T} in Equation 5 that will use a lot of homomorphic rotations, which are computationally very expensive. The mapping matrix A∈ [symbol] ^{d×dL} is a rectangular matrix that is not suitable for the efficient FHE vector-matrix product design for square matrices, which can be rewritten as A=[A₁, A₂, . . . , A_{L}] where Aᵢ∈ [symbol] ^{d×d}, 1≤i≤L, and the vector-matrix product can be decomposed as:

$$y = {\sum }_{i = 1}^{L} ( {yiA}_{i}^{T} + \frac{b}{L} ) , where yi ∈ {ℝ}^{d} , {A}_{i} ∈ {ℝ}^{d \times d} \qquad ( 7 )$$

wherein the vector-matrix product

$${yiA}_{i}^{T} + \frac{b}{L}$$

can pe evaluated in parallel. The fusion function becomes a simple addition, computationally the cheapest operation on FHE. Existing CNNs using FHE are not scalable to arbitrary-resolution images. When the image size is increased, the latency on FHE will significantly accumulate because the ciphertext multiplication complexity is [symbol] ( [symbol] ²N log N) The proposed mixture of PCNNs is scalable to arbitrary resolution. The number of PCNNs may be increased while maintaining fast inference thanks to the parallelism of CryptoFaceNet.

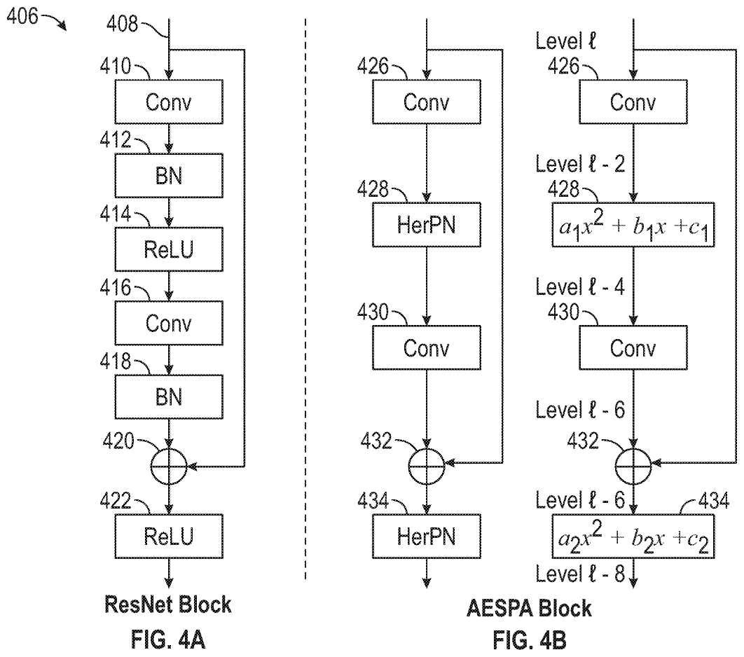

In FIG. 4A, a typical ResNet Block system 406 is illustrated. ResnNet Block systems may include an input 408, a first Convolutional Layer 410 that learns features. Batch Normalization (BN) 412 normalizes activations for faster, stable training. ReLU Activation 414 introduces non-linearity. A second Convolutional Layer 416 learns further features. A batch normalization (BN) 418 performs a second normalization. A skip connection/addition block 420 adds the original input to the output of step the BN 418. A final ReLU 422 activates the combined output.

Referring now to FIG. 4B, convolutional layers use ciphertext-plaintext multiplication and rotation under FHE. A recent efficient multiplexed parallel convolution (MP-Conv) is applied that introduces a multiplexed packing algorithm to reduce expensive rotation operations. Non-linear activation functions, like ReLU, are not supported by FHE and are substituted by polynomial functions. Hermite polynomial activation (HerPN), a low-degree basis-wise normalized polynomial, is adopted as an activation function from AESPA. HerPN has shown competitive performance, especially for shallow networks. AESPA modified the ResNet block and is designed for secure multi-party computation (MPC). FIG. 4B shows its implementation under FHE. The AESPA block depth is eight because one Conv 426 consumes two levels, and one HerPN 428 consumes two levels. A shifted AESPA block is therefore set forth. HerPN 428 and 434 can be formulated as a degree-2 polynomial αx²+bx+c with depth 2. A second CONV 430 is illustrated. The coefficient α to Conv weight is used and the polynomial is changed to

$${x}^{2} + {}_{a}^{b} x + \frac{c}{a}$$

with depth 1. A skip connection/addition block 432 is disposed after the convolution 430. A second herPN 434 is provided at each of the two levels. Therefore, the proposed CryptoFace block can save two levels.

Polynomial L2 normalization is performed. When compute cosθ between two features y₁, y₂ is computed, features

$$\frac{y 1}{‖ y 1 ‖} , \frac{y 1}{‖ y 1 ‖}$$

(Equation 3) are normalized. Existing non-end-to-end encrypted approaches do not address this problem because features are normalized before encryption. L2 normalization can be expressed as

$$\frac{y 1}{‖ y ‖ 2} = y \cdot \frac{1}{\sqrt{{\sum }_{i = 1}^{d} {y}_{i}^{2}}} .$$

The expression [yᵢ]² can be computed via ciphertext-ciphertext multiplication and obtain

$${{\sum }_{i = 1}^{d} [ yi ]}^{2}$$

under FHE. So, a polynomial is used to approximately

$$q ( t ) = \frac{1}{\sqrt{t}} .$$

The challenge is that the domain of q(t) is very wide because

$$t = {‖ y ‖}_{2}^{2} .$$

Taylor expansion of q(t) results in a high-degree polynomial at t=t₀. Minimax approximation is not suitable because non-linear q(t) to [−1, 1] cannot be scaled which is required by minimax approximation. The expression

$$q ( t ) = \frac{1}{\sqrt{t}}$$

is notably a strictly decreasing function and use a polynomial function p(t)=β₂t²+β₁t+B₀ to approximate q(t). But instead of minimizing |p(t)−q(t)| like Minimax approximation, only p(t) is pushed to have a shape that is roughly similar to q(t) in the domain of q(t). Control points t₁, t₂, t₃, and corresponding reference values

$$\frac{1}{\sqrt{{t}_{1}}} , \frac{1}{\sqrt{{t}_{2}}} , \frac{1}{\sqrt{{t}_{3}}}$$

are used to solve p(t) coefficients β₂, β₁, β₀. p(t) is a distribution-aware function. Control points are set to t₁=Mean(t)+Std(t), t₂=Mean (t), t₃=Mean (t)+Std(t). p(t) coefficients are distribution-dependent parameters like the score threshold. The depth of p(t) is only 2. The effectiveness of L2 polynomial approximation is illustrated.

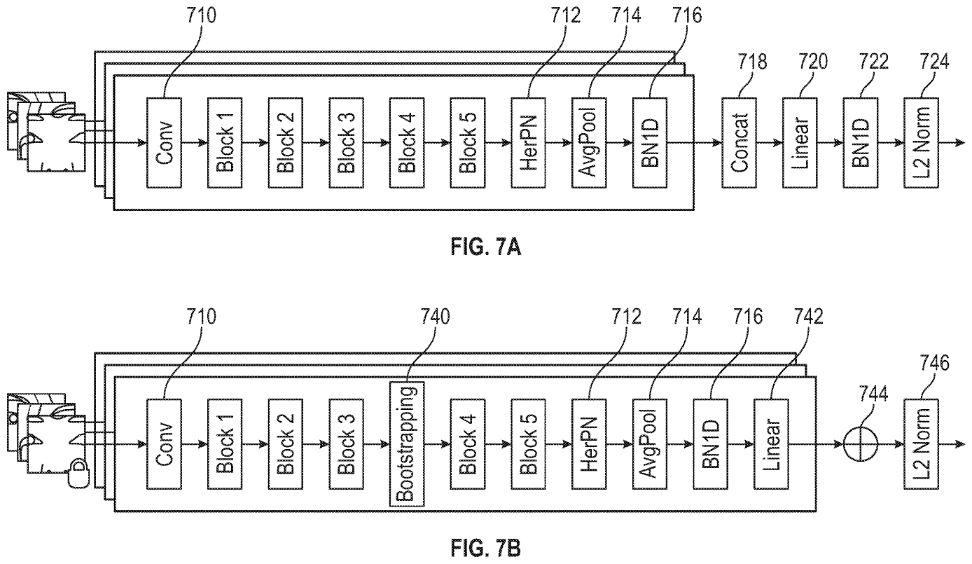

Referring now to FIGS. 7A and 7B, CryptoFaceNet architecture is shown. In FIG. 7A, a training architecture use on a plain text data is illustrated. In FIG. 7B the system is used for homomorphic inference.

FIG. 7A has a Covolution Layer 710, Blocks 1-5 a HerPN layer 712, an average pool layer 714 and a Batch Normal one-dimensional layer (BN1D) 716. There may be multiples of this grouping in parallel. Each grouping may be followed by a concatenation block 718, a linear block 720, another BN1D block 722 and a level 2 normalization block 724.

In FIG. 7B, is a similar architecture except that a bootstrapping block is between Blocks 3 and 5. And the linear block 742 is moved into each parallel grouping after BN1D block 716. A summing block 744 sums the group and provides the sum the level 2 normalization block 746. To reduce depth consumption, CryptoFaceNet fuses the Linear and BatchNorm1D layers to a single Linear. The aggregation of features is a simple ciphertext addition. CryptoFaceNet only uses one bootstrapping operation.

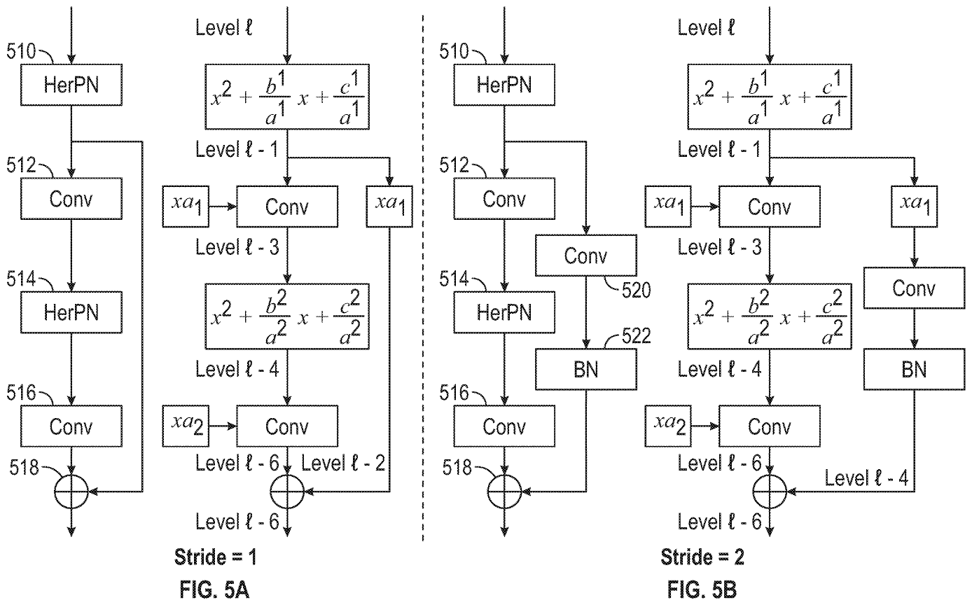

The proposed CryptoFaceNet is used and its homomorphic architecture. The proposed CryptoFaceNet block is simplified in FIG. 5A with stride=1. FIGS. 5A and 5B shows CryptoFaceNet blocks for stride=1 and stride=2. HerPN can be formulated as a degree-2 polynomial αx²+bx+c with depth 2. The coefficient α to Conv weight may be fused and polynomial changed to

$${x}^{2} + \frac{b}{a} x + \frac{c}{a}$$

with depth 1. Therefore, the proposed CryptoFaceNet block can save two levels. The Crypto FaceNet block has two situations as shown in FIGS. 5A and 5B.

In FIG. 5, and one HerPN 510 consumes two levels. HerPN 510 is followed by one Conv 512 another HerPN 514 and a Conv 516 The coefficient Conv weight is used and the polynomial is changed to x²+(b₂/a₂)+(c₂/a₂) with depth 1. A skip connection/addition block 518 is disposed after the convolution 516.

When stride=2 as in FIG. 5B, a Conv-BN layer is used to match the tensor size in the bypass path. That is, a convolution layer 520 followed by a BN 522 is provided in the bypass path. The residual connection (addition) takes two ciphertexts as input. The modulus of the ciphertext with the higher level (l-2 or l-4) to l-6 are used. HerPN is formulated as αx²+bx+c where x is a three-dimensional tensor with C channels. Polynomial coefficients α, b, c have C dimensions. The multiplexed packing is applied to pack the tensor x. Accordingly, coefficients α, b and c are packed to match the packed x.

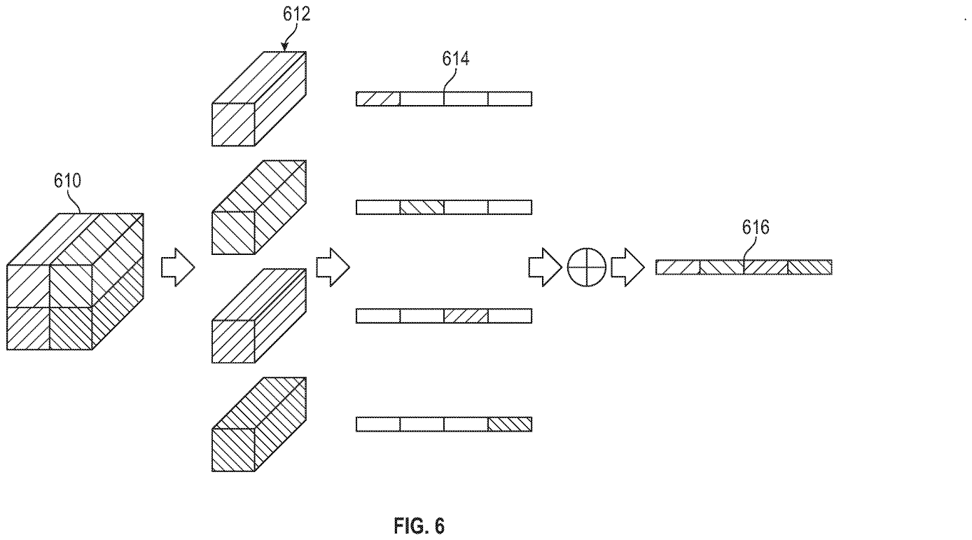

The two-dimensional adaptive average pooling system with output size (2, 2) is shown in FIG. 6. The input tensor 610 is multiplexed packed in 612. The proposed average pooling is used to obtain 256-dimensional features 614 for face recognition. (2, 2) average pooling can be regarded as four (1, 1) average pooling operations. Unlike (1, 1) average pooling proposed in MPCNN. The proposed (2, 2) average pooling will permute numbers of the feature. The matrix weight of the following linear layer only needs to permuted to obtain the output 616. The matrix weight is plaintext data, so it will not introduce any computational costs on CKKS.

Datasets: (1) Training dataset: WebFace4M is used, which is a subset of WebFace260M to train CryptoFace and baselines on plaintext data in Pytorch. WebFace4M has 205,990 identities and 4,235,242 face images in total. (2) Test datasets: the state-of-the-art FR model AdaFace is used to extensively benchmark CryptoFace and baselines on five popular test datasets: LFW, AgeDB, CALFW, CPLFW, CFP-FP. These datasets extensively show the effect of illumination, background, age, pose and etc. The face images are adopted by InsightFace. InsightFace pairs two face images and provides a Boolean label. The image resolution is 112×112. In experiments, the face images are resized to small (64×64), medium (96×96), and high-resolution (128×128), which satisfies use cases corresponding to edge FR, embedded FR, and cloud FR in real-world applications. It is noted that most existing CNNs designed for image classification over LHE or FHE are only tested on the CIFAR dataset with 10,000 images at a resolution of 32×32. In contrast, CFP-FP has 7,000 pairs, resulting in 14,000 face images, while others have 6,000 pairs, resulting in 12,000 face images. There is a one-to-one verification accuracy on the encrypted test datasets.

The FHE library and hardware use the Microsoft Simple Encrypted Arithmetic Library (SEAL), a widely-used CPU-accelerated FHE library in Machine Learning, as the RNS-CKKS FHE implementation in the experiments. The modified version of MPCNN is used, which implements bootstrapping. GPU acceleration is orthogonal to the goal. AutoFHE is followed to report latency and memory footprint on Amazon AWS r5.24xlarge.

As there is no prior end-to-end encrypted FR approaches, two recent approaches are adopted which are designed for image recognition under FHE, MPCNN and AutoFHE as the baselines because they report the state-of-the-art performance on image classification. MPCNN and AutoFHE use the same packing algorithm. The C++ implementation of CryptoFace is built on top of MPCNN and AutoFHE. There are other possible baselines. CryptoFace is not compared with them because (1) LHENets reported inferior prediction accuracy on image classification, and (2) They have different packing algorithms and are built on different libraries. As MPCNN and AutoFHE are not designed for face recognition, The proposed modules are applied for face recognition, like the polynomial approximation for L2 normalization. AutoFHE is a search-based approach and reports search results on the CIFAR dataset. Extending the search algorithm from a small CIFAR dataset to the much larger WebFace dataset is challenging. The search result is used on CIFAR, transfer it to the WebFace dataset, and denote it as AutoFHE.

Two FHE baselines MPCNN and AutoFHE were adopted because they use the same packing methods. CryptoFace was implemented on the CKKS using the same packing methods to ensure the same computational complexity of operations on CKKS. Furthermore, CryptoFace can use any possible advanced packing methods. The original MPCNN and AutoFHE are designed for tiny images with a resolution of 32×32. A resolution of 64×64 allows enough visual clues for face recognition. The stride of the very first convolutional layer is changed from 1 to 2 to ensure that a single ciphertext can pack any intermediate tensors. MPCNN and AutoFHE are proposed for the classification tasks, CIFAR-10 or CIFAR-100. They feed 64-dimensional features to a fully-connected classifier. 64-dimensional features are obtained by an average pooling layer with the output size (1, 1). Face recognition necessitates using high-dimensional features. An average pooling layer with output size (2, 2) is used to get 256-dimensional features. The original output layers are AdaptiveAvgPool2d ((1, 1)) [symbol] Linear (64, 10 or 100). The new output layers used for face recognition are AdaptiveAvgPool2d ((2,2)=>Linear (256, 256) [symbol] BatchNorm1d (256).

For training, the parameters from AdaFace were adopted without tuning. The learning rate is set to 0.05, epochs to 26, batch size to 256, momentum to 0.9, and weight decay to 0.0005. The SGD optimizer with multi-step scheduler is used. The learning rate is scaled by 0.1× at epochs 12, 20, and 24. When CryptoFace and AutoFHE are trained, the gradient is set to 1 as suggested. The patch size is set to 32×32. The strength of the jigsaw loss is set to 0.005. With FHE to meet 128-bit security, the same CKKS parameters are used as MPCNN and AutoFHE. The degree of the cyclotomic ring is 216 and Hamming weight is 192. The default modulus is set to 46 bits and the special modulus to 51 bits.

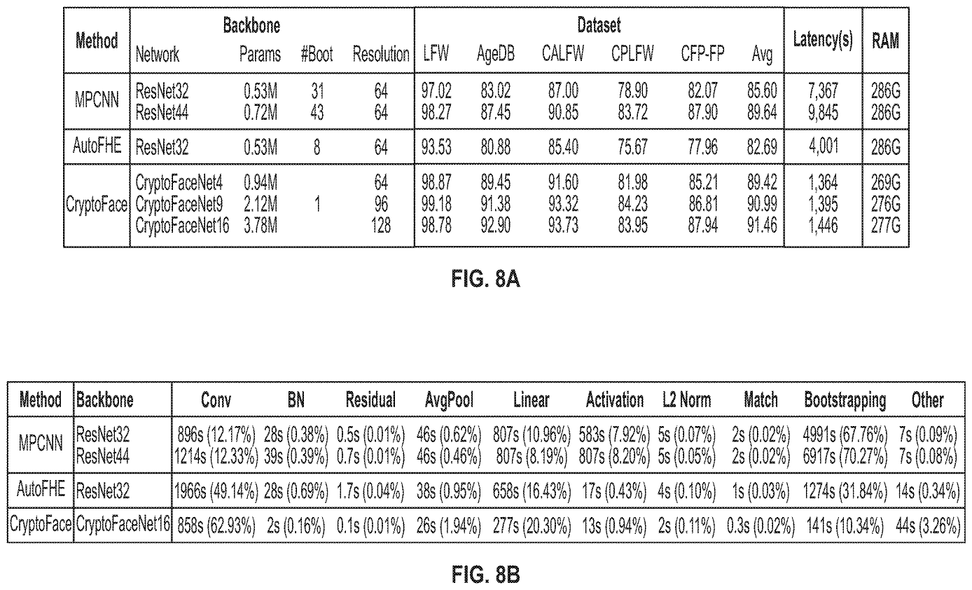

With respect to encrypted face recognition on FHE, the standard 10-fold cross-validation was used to benchmark CryptoFace and baselines on the encrypted face datasets. For each split, nine groups (plaintext) are used to estimate the threshold and polynomial approximation of L2 normalization, while the standalone group (ciphertext) is used to test performance. 248,000 encrypted 64×64 face images used in total. The average verification accuracy of 10-fold cross-validation for each dataset (Table 1) was used. The online latency and memory footprint are tested on an AWS r5.24xlarge CPU instance. For a pair of face images, the first as the reference and the second as the probe was used. Each experiment includes an offline and an online stage. The offline stage uses a neural network to extract an encrypted reference feature from the encrypted reference face. The online stage extracts the encrypted probe feature and then verifies these two encrypted features. The online latency is set forth in the table of FIG. 8A.

MPCNN with ResNet44 shows the highest accuracy (89.64%) but a prohibitively large latency (9,845 seconds). CryptoFace greatly accelerates encrypted face recognition by 7.2 times which translates to savings of 8,481 seconds. A negligible accuracy drop of 0.22% was observed. MPCNN with ResNet32 is a faster version but only achieves 85.60% accuracy. CryptoFace speeds up inference by 5.4× and increases face recognition performance by +3.82%. AutoFHE is much faster than MPCNN. However, the transferred AutoFHE achieves 82.64% on encrypted face recognition with a latency of 4,001 seconds. Compared to AutoFHE, CryptoFace accelerates inference by 2.9× and improves the encrypted face recognition performance by 6.73%. CryptoFace also reduces memory footprint by 16G because only one bootstrapping key is needed, while the baselines require three. The experimental results demonstrate the effectiveness of end-to-end encrypted face recognition systems. The proposed CryptoFaceNet is an efficient FHE ML system thanks to the mixture of shallow CNNs and the novel parallelism.

The effect of the resolution of encrypted face images on verification accuracy, latency, and memory footprint is shown. Experiments were conducted on encrypted AgeDB and CALFW datasets and report the verification accuracy on the first split of 10-fold cross-validation. 112×112 face images were resized to 64×64, 96×96 and 128×128. The patch size of 32×32 was used. From the experimental results, observation: i) CryptoFace can take advantage of high-resolution face images to effectively improve the face recognition performance; ii) CryptoFace can maintain a relatively constant latency (1364 to 1446 seconds) even as the image resolution increases from 64×64 to 128×128. iii) CryptoFace slightly increases the memory footprint from 269G to 277G. These results demonstrate that CryptoFace is scalable to high-resolution images and can satisfy different requirements in real-world face recognition applications.

In FIG. 8B a table lists detailed latency of different operations. Bootstrapping operations dominate the latency of MPCNN, around 70%. AutoFHE successfully removes most bootstrapping operations by using mixed-degree polynomial activations. CryptoFace fundamentally decreases the depth of networks and significantly reduces the number of bootstrapping operations to one with bootstrapping only contributing 10% to the total latency. The parallelism of CryptoFaceNet on FHE introduces an acceptable overhead, around <3.26% (Other). CryptoFace and MPCNN (ResNet32) spend roughly equal time evaluating convolutional layers. However, MPCNN (ResNet32) has 31 convolutional layers, and one patch CNN only has 13 (including two residual convolutional layers) since CryptoFaceNet convolutional layers take high-level ciphertext as input, leading to higher latency. Both AutoFHE and CryptoFace benefit from low-degree polynomial activations because expensive ciphertext-ciphertext multiplications are decreased. A 2D average pooling (AvgPool) with output (2, 2) was used to get 256-dimensional features. The (2, 2) Avg-Pool is slower than (1, 1) AvgPool used by the original versions of MPCNN and AutoFHE because it introduces more rotations. However, face recognition necessitates high-dimensional features. The proposed polynomial approximation of L2 normalization and the feature matching are very efficient under FHE. CryptoFaceNet is a level-optimized homomorphic neural architecture demonstrating lower latency over different FHE operations.

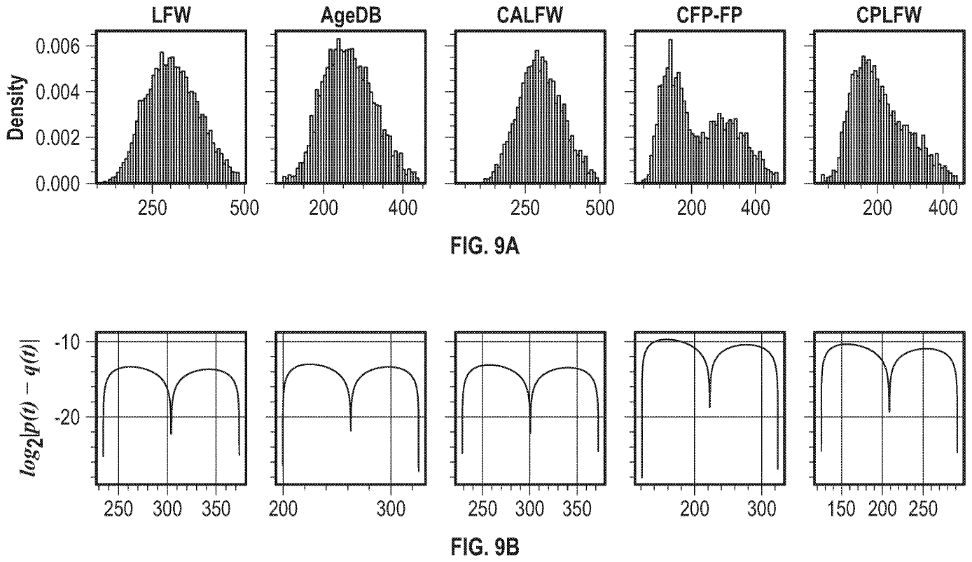

FIG. 9A shows the distribution of

$${‖ y ‖}_{2}^{2} ,$$

namely the domain q(t)=1/\sqrt{t}. A distribution-aware polynomial approximation p(t) [symbol] q(t) is set forth. FIG. 9B shows the approximation error is log₂|p(t)−q(t)|≤2⁻¹⁰. The proposed polynomial approximately is accurate and efficient (2s latency on FHE).

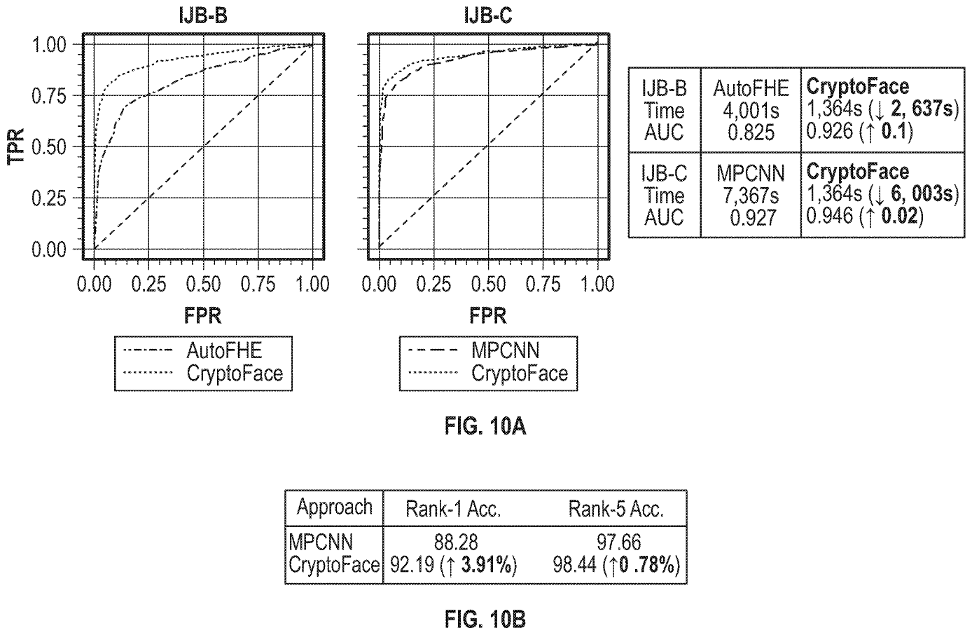

Referring now to FIGS. 10A and 10B, experiments on mixed-quality benchmarks were performed. Below, results on a subset of IJBB and IJBC (1200 random pairs with 50%+ve and −ve pairs) are shown due to very high computational costs.

Identification. 1:128 closed-set rank retrieval result on a subset of LFW (128 random pairs). Latency difference is only from feature extract which is already reported.

CryptoFace is a first demonstration of an end-to-end encrypted face recognition system using fully homomorphic encryption. Once raw face images are encrypted, all subsequent operations like feature extraction, template matching, and score thresholding were performed in the encrypted domain without decryption. CryptoFace is a mixture of shallow patch convolutional neural networks optimized for FHE compatibility and mitigating the steep computational burden of encrypted inference. Experimental results on multiple benchmark datasets show that CryptoFace is 7.2× faster than state-of-the-art FHE-based neural networks adapted for face recognition at the same performance level. Another research line of secure machine learning takes advantage of secure multi-party computation (MPC) and reports lower latency and higher communication cost than FHE-based solutions. Secure MPC requires interactive computation and communication between client and server. FHE is a non-interactive framework and provides a fire-and-forget service to clients.

Although the results demonstrate the potential for achieving large efficiency gains by rethinking neural network designs to enhance compatibility with the unique constraints of operations supported by FHE schemes, the latency of CryptoFace at ~1300s on CPU per image is still impractical for real-world applications. Much more progress remains to be made to practically realize the security benefits of end-to-end crypted face recognition. GPU acceleration of CryptoFace is a promising avenue for realizing significant gains in latency.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python.

What is claimed is:

1. A method for performing secure biometric recognition comprising:
encrypting a biometric sample to form encrypted biometric data;
communicating the encrypted biometric data to a feature extractor;
extracting features from the encrypted biometric data to form encrypted extracted features;
performing a biometric verification or a search on the encrypted extracted features;
forming an encrypted output signal based on results of the verification or the search; and
communicating the encrypted output signal to a client device.

2. The method of claim 1 further comprising:
decrypting the encrypted output signal at the device; and
generating a display corresponding to the results.

3. The method of claim 2 wherein encrypting the biometric sample comprises encrypting the biometric sample with a key and wherein decrypting the encrypted output signal comprises decrypting the encrypted output signal with the key.

4. The method of claim 2 wherein encrypting the biometric sample comprises encrypting the biometric sample with a key at the client device and wherein decrypting the encrypted output signal comprises decrypting the encrypted output signal with the key at the client device.

5. The method of claim 1 wherein encrypting comprises homomorphic encrypting.

6. The method of claim 1 wherein the biometric sample comprises a fingerprint data, iris scan data or facial data.

7. The method of claim 1 wherein performing biometric verification or a search comprises performing biometric verification using the encrypted biometric data.

8. The method of claim 1 wherein performing biometric verification or the search comprises performing the search using the encrypted biometric data.

9. The method of claim 1 wherein prior to extracting features performing biometric verification or the search dividing the encrypted biometric data into patches.

10. The method of claim 9 further comprising extracting features from the patches to form local patch features.

11. The method of claim 10 further comprising aggregating the local patch features to form the encrypted extracted features.

12. The method of claim 1 further comprising training a neural network with encrypted biometric training data.

13. A system for performing secure biometric recognition comprising:
a client device encrypting a biometric sample to form encrypted biometric data;
a server and a feature extractor receiving the encrypted biometric data through a network, the feature extractor extracting features from the encrypted biometric data to form encrypted extracted features; and
the server performing a biometric verification or a search on the encrypted extracted features, forming an encrypted output signal based on results of the verification or the search, and communicating the encrypted output signal to a client device.

14. The system of claim 13 wherein the client device decrypts the encrypted output signal and generating a display corresponding to the results.

15. The system claim 14 wherein the client device encrypts the biometric sample with a key and decrypts the encrypted output signal with the key.

16. The system claim 13 wherein the client device or server divides the encrypted biometric data into patches.

17. The system of claim 16 wherein the server extracts features from the patches to form local patch features.

18. The system of claim 17 wherein the server aggregates the local patch features to form the encrypted extracted features.

19. A method for performing secure biometric recognition comprising:
encrypting a facial image in patches to form a plurality of encrypted patches;
communicating the encrypted patches to a feature extractor though a network;
extracting features from the encrypted patches to form encrypted extracted features;
performing a biometric verification or a search on the encrypted extracted features;
forming an encrypted output signal from the based on results of the verification or the search; and
communicating the encrypted output signal to a device.

20. The method of claim 19 wherein prior to performing the biometric verification, aggregating the features from each patch to form an aggregation and wherein performing the biometric verification comprises performing the biometric verification or search based on the aggregation.
